(19) United States
(12) Patent Application Publication
(10) Pub. No.: US 2026/0143305 A1
(43) Pub. Date: May 21, 2026

(54) SYSTEM FOR GENERATING AUTOMATICALLY AND PREDICTING NETWORK COVERAGE MAPS OF AUTONOMOUS VEHICLES, AND PREDICTION METHOD USING THE SAME

(71) Applicant: ACEWORKS KOREA Inc., Seoul (KR)

(72) Inventor: Minseo KIM, Seoul (KR)

(21) Appl. No.: 19/386,591

(22) Filed: Nov. 12, 2025

(30) Foreign Application Priority Data
Nov. 15, 2024 (KR) 10-2024-0163314

(51) Int. Cl. H04W 4/024; H04W 4/40; H04W 64/00

(52) U.S. Cl. CPC H04W 4/024; H04W 4/40; H04W 64/006

(57) ABSTRACT

An embodiment relates to a system for generating automatically and predicting network coverage maps of autonomous vehicle, including a map-mapping unit that collects network speed and quality data for a plurality of base stations from a control center by time of day, day of the week, and date and maps them onto a geographic map to generate coverage maps representing network condition, a route search unit that searches for a driving route to the destination by linking with the map-mapping unit,; a data collection unit that collects data on current states of the autonomous vehicle including at least location, date, day of the week, time, network speed, and quality data of the autonomous vehicle; and a prediction algorithm that predicts network condition of coverages mapped on the driving routes, but predicts the network condition according to expected arrival time and date of the autonomous vehicle.

### CROSS-REFERENCE TO RELATED APPLICATION

This application is based on and claims priority under 35 U.S.C. §119 to Korean Patent Application No. 10-2024-0163314, filed on November 15, 2024, in the Korean Intellectual Property Office, the disclosures of which are incorporated by reference herein in its entirety.

### BACKGROUND OF THE INVENTION

### Field of the invention

The present disclosure relates to a location-based autonomous driving technology using a public cellular network, and relates to a system for generating automatically and predicting network coverage maps of autonomous vehicle, which collects real-time network data to automatically generate coverage maps to provide a stable communication environment for autonomous vehicle, and predicts a network speed for a future target location through the generated coverage maps, and a prediction method using the same.

This invention is a result of research on a project (Project No. 1615013297) supported by the Ministry of Land, Infrastructure and Transport/Korea Agency for Infrastructure Technology Advancement.

### Background of the Related Art

A current public cellular network is able to measure network speeds (uplink, downlink) in real time, but this information alone has limitations in accurately predicting network condition at a specific location in the future.

FIG. 1 is a diagram showing an example in which a condition of a public cellular network becomes irregular due to irregular events.

The speed of the public cellular network is affected by regular events such as times, places, and population densities as well as irregular events such as weather, base station problems, and local events. However, while regular events are predictable, irregular events are difficult to predict and real-time measurements are also not easy.

In an autonomous driving technology, infrastructure communication (Vehicle to Infrastructure (V2I)) such as remote driving is heavily dependent on such network performance, and as a result, fluctuations in network condition have a significant impact on the safety of autonomous driving systems. Additionally, because it is difficult to predict the network speed along the driving route in advance, there is a problem in that it is difficult to immediately respond to communication instability.

Therefore, the present disclosure aims to provide a method for monitoring the communication environment of autonomous driving technology using a public cellular network in real time and, although it is difficult to measure accurately even for irregular events, predicting them based on past data to solve network instability problems in advance.

Related prior art literature includes Korean Patent Publication No. 10-1924736 (Title of the invention: Autonomous traveling road event monitoring system and its control method using real time traffic variation of wireless channel in V2X environments, Registration date: 2018.11.27.). This proposes a method for monitoring an event situation by an increase or decrease in traffic of the corresponding base station without a separate sensor or wireless data information transmission, by using the fact that traffic increases in the wireless channel of a specific base station due to traffic congestion when an accident or vehicle breakdown occurs on the road ahead in a V2X environment. However, the prior literature detects (recognizes) event situations through network traffic changes, and does not have a function to predict or prepare for network problems in advance.

### CITATION LIST

### Patent Literature

(Patent Document 1) Korean Patent Registration No. 10-1924736 (Registration date: November 27, 2018)

### SUMMARY OF THE INVENTION

An aspect of the present disclosure is to provide a system and method for generating automatically and predicting network coverage maps of autonomous vehicle, which are able to generate coverage maps by mapping network speed or network quality data (e.g., traffic information) collected by time zone, day of the week, and date onto a map, and predict future location-based network condition through the generated coverage map and current network condition.

In addition, another aspect of the present disclosure is to allow an autonomous vehicle using a public cellular network to recognize various fluctuation events (event situations) that are able to occur in a driving route to a target destination and an expected arrival time to the target destination so as to avoid crowded situations or selecting an optimal route.

Moreover, still another aspect of the present disclosure is to be applied to a location-based system using a public cellular network as well as autonomous vehicle so as to predict future location/route-based network condition and appropriately respond to network fluctuations.

The foregoing objectives are able to be achieved by a system for generating automatically and predicting network coverage maps of autonomous vehicle, the system including a map-mapping unit that collects network speeds and quality data for a plurality of base stations from a control center by time of day, day of the week, and date and maps them onto a geographic map to generate coverage maps representing network condition; a route search unit that searches for a driving route to the destination by linking with the map-mapping unit, when target information including current location and destination of the autonomous vehicle is input; a data collection unit that collects data on current states of the autonomous vehicle including at least location, date, day of the week, time, network speed, and quality data of the autonomous vehicle; and a prediction algorithm that performs learning based on the coverage maps generated by the map-mapping unit and the current state that changes according to the driving of the autonomous vehicle, which is collected by the data collection unit to predict network condition of coverages mapped on the driving routes, but predicts the network condition according to expected arrival time and date of the autonomous vehicle.

In this case, the prediction algorithm identifies event situations corresponding to expected arrival time zone for each location on the driving routes based on the past coverage maps of the same day and the same time zone generated by the map-mapping unit and current network condition of the autonomous vehicle, and compares relationships between current network speed and quality data of the current autonomous vehicle based on the past network condition mapped to the coverage maps generated by the map-mapping unit, so as to predict the network condition of target location, which will arrive shortly.

The route search unit provides, when providing a final searched driving route, data including a network prediction speed predicted through the prediction algorithm.

In addition, the route search unit is able to search for, when a network prediction speed predicted through the prediction algorithm is lower than a preset reference value, another driving route.

In addition, the route search unit is able to apply, when there are a plurality of driving routes to the destination, network speed of coverages mapped to the plurality of driving routes to a prediction algorithm so as to prefer entially provide a driving route with a high network speed among the plurality of driving routes.

Meanwhile, the foregoing objectives are able to be achieved by a method for generating automatically and predicting network coverage maps of autonomous vehicle, the method including collecting, by a map-mapping section of a system, network speed and quality data for a plurality of base stations from a control center by time of day, day of the week, and date; mapping, by the map-mapping unit, the collected network speed and quality data onto a geographic map to generate coverage maps representing network condition by location, time zone, day of the week, and date; collecting, by a data collection unit of the system, data on current state of the autonomous vehicle including at least location, date, day of the week, time, network speed, and quality data of the autonomous vehicle; and performing, by a prediction algorithm of the system, learning based on the coverage maps generated by the map-mapping unit and the current state that changes according to the driving of the autonomous vehicle collected by the data collection unit to predict network speed for specific time, location, and date.

In addition, the foregoing objectives are able to be achieved by a method for generating automatically and predicting network coverage maps of autonomous vehicle, the method further including receiving, by a route search unit of the system, target information including current locations and destinations of the autonomous vehicle; searching for, by the route search unit, driving route to the destination by linking with the map-mapping unit; and performing, by the prediction algorithm, learning based on the coverage maps generated by the map-mapping unit and the current state that changes according to the driving of the autonomous vehicle to predict network condition of coverages mapped on the driving routes, but predict the network condition according to expected arrival time of the autonomous vehicle and date.

In this case, the predicting of the network condition identifies event situation corresponding to expected arrival time zones for each location on the driving routes based on the past coverage maps of the same day and the same time zone generated by the map-mapping unit and current network condition of the autonomous vehicle, andcompares relationships between network speeds and quality data of the current autonomous vehicle based on the past network condition mapped to the coverage maps generated by the map-mapping unit so as to predict the network condition of target location, which will arrive shortly.

According to the present disclosure, it is possible to respond to communication instability in advance in a real-time changing road environment, thereby having an effect of enhancing the safety of autonomous vehicle.

In addition, according to the present disclosure, a map coverage map is generated based on network speeds collected by time zone, day of the week, and date, and the generated coverage map is applied to machine learning to provide a function of predicting future location-based network speeds, thereby having an effect of being able to recognize and prepare for communication instability problems in advance even if an event situation involving irregular fluctuation events occurs.

In particular, when autonomous vehicle perform infrastructure communication such as communication with a remote control center in real time, it is possible to secure safety by responding in advance, such as re-searching a route or recommending another driving route for a location where the network environment is unstable on the driving route.

In addition, according to the present disclosure, it is possible to be utilized to predict future location/route-based network condition and optimize routes in various industrial fields such as drones, robot deliveries, smart city infrastructures, and mobility services as well as autonomous driving systems. For example, it is possible to be utilized to analyze and optimize network condition in advance while driving to ensure that unmanned taxis carrying passengers are able to receive a smooth communication environment. For smart city infrastructures, it is possible to be utilized for real-time network performance monitoring and prediction in urban traffic control and data collection systems, and related algorithms are able to be pre-tested and verified by implementing actual network condition in a virtual environment.

In addition, the present disclosure is able to be applied to the following fields in the future.

6G-based autonomous driving and communication systems: In a 6G environment that requires higher bandwidth and lower latency, coverage prediction system for autonomous vehicle will become essential.

Real-time data management in smart cities: It is possible to play an important role in managing communication networks across the city and ensuring smooth communication between vehicles and infrastructure.

Logistics and autonomous transportation systems: It is possible to develop into a technology that predicts and manages communication stability along routes in large-scale logistics networks.

Telemedicine and emergency systems: It is possible to be applied to predict network condition and ensure reliability in autonomous emergency vehicles or remote medical support systems.

### BRIEF DESCRIPTION OF THE DRAWINGS

FIG. 1 is a diagram showing an example in which a condition of a public cellular network becomes irregular due to irregular events.

FIG. 2 is a configuration diagram showing a system for generating automatically and predicting coverage maps of autonomous vehicle according to an embodiment of the present disclosure.

FIG. 3 is a diagram showing a network speed by time and date on a driving route through the system of FIG. 2.

FIG. 4 is an operational flowchart showing a method for automatically generating coverage maps of autonomous vehicle according to an embodiment of the present disclosure.

FIG. 5 is an operational flowchart showing a method for predicting network condition along driving route of autonomous vehicle based on the coverage maps generated by the method of FIG. 4.

### DETAILED DESCRIPTION OF THE PREFERRED EMBODIMENT

In order to fully understand the present disclosure, operational advantages thereof and objects achieved by embodiments of the present disclosure, it is necessary to refer to the accompanying drawings illustrating a preferred embodiment of the present disclosure and the contents described in the accompanying drawings.

Hereinafter, preferred embodiments of the present disclosure will be described in detail with reference to the accompanying drawings. However, in describing the present disclosure, a description of a function or configuration already known will be omitted in order to clarify the subject matter of the present disclosure.

In addition, while the present disclosure is described with respect to autonomous vehicle using a public cellular network, but it is possible to be applied to unmanned taxis, unmanned robots, drones, unmanned mobility, and the like, as well as the autonomous vehicle. For convenience of explanation, they will be collectively referred to as autonomous vehicle in the present disclosure.

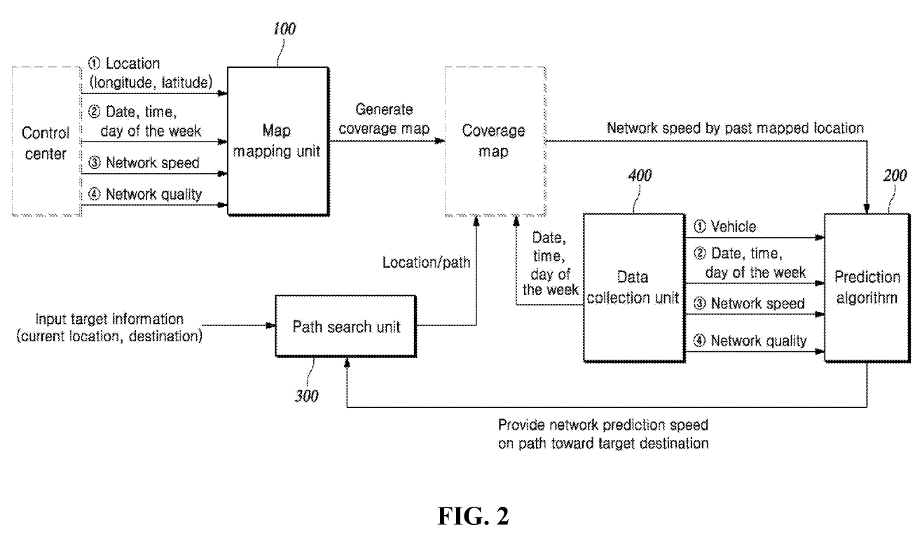

FIG. 2 is a configuration diagram showing a system for generating automatically and predicting coverage maps of autonomous vehicle according to an embodiment of the present disclosure.

The system for generating automatically and predicting coverage maps of autonomous vehicle according to an embodiment of the present disclosure includes a map-mapping unit 100, a prediction algorithm 200, a route search unit 300, and a data collection unit 400.

The map-mapping unit 100 collects network speed and quality data for a plurality of base stations from a control center by time of day(time zone), day of the week, and date and maps them onto a geographic map to generate coverage maps representing network condition.

Here, the control center is built into the system (or server) that provides autonomous driving services and is responsible for receiving and monitoring all data related to autonomous driving. The control center is able to communicate with a plurality of base stations and collect network speed and quality data therefrom, or acquire network speed and quality data from a base station control center (not shown) that communicates with the plurality of base stations.

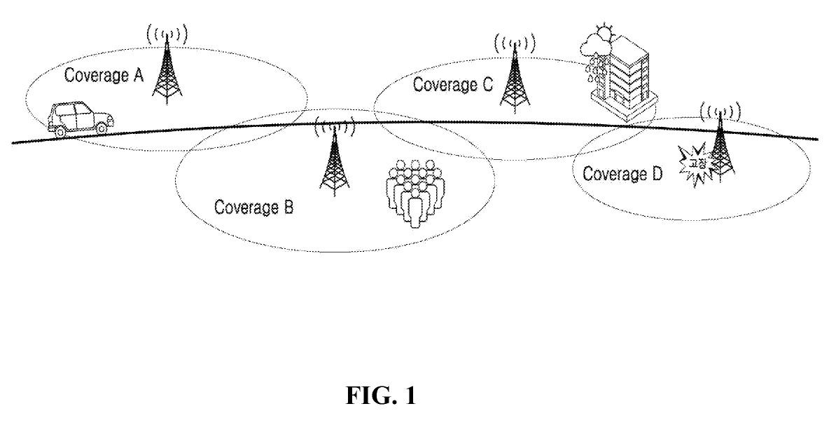

The plurality of base stations are connected to allow wireless communication within a coverage (coverage A, coverage B, coverage C, coverage D, etc.) having a preset radius, as illustrated in FIG. 1. Therefore, when an autonomous vehicle enters a coverage of one of a plurality of base stations, communication is performed through the base station in the corresponding coverage.

In this case, the plurality of base stations are connected to the control center or the base station control center (not shown) to transmit the locations, times, dates, number of connected users, and the like, of terminals (autonomous vehicle) entering the coverage managed by each base station to the control center or the base station control center.

The control center measures and manages a network condition for each base station based on data received from the plurality of base stations. Additionally, the control center transmits a network condition for each base station to the system of the present disclosure so as to allow the map-mapping unit 100 to use it to generate a coverage map.

Here, a coverage map refers to a map showing an area where network communication is possible, and it is possible to check a location (route) where the network condition is smooth through a network coverage maps of the present disclosure.

The data collection unit 400 collects data on current states of the autonomous vehicle including at least locations, dates, days of the week, times, network speeds, and quality data of the autonomous vehicle. Through the data collected in this manner, the data collection unit 400 is able to check current state of the autonomous vehicle that changes while driving in real time.

The prediction algorithm 200 performs learning based on the coverage maps generated by the map-mapping unit 100 and the current states of the autonomous vehicle collected by the data collection unit 400, that is, current state that changes according to the driving of the autonomous vehicle to predict network condition for a specific future time and date based on locations.

In particular, the prediction algorithm 200 is able to predict network condition of the corresponding coverages along the searched driving routes to the target destination by linking with the route search unit 300 according to expected arrival time of the autonomous vehicle and date (day of the week).

When making predictions, regular fluctuation events such as commuting time, place, and population density are able to be reflected as fluctuation events that change condition of networks. For example, when an expected arrival time for an autonomous vehicle to move from point A to point B is 6 pm, which is one hour later, a network speed at point B through the coverage map is a current speed, but a network speed at point B through the prediction algorithm 200 provides a network prediction speed learned at 6 pm, which is one hour later, in line with the end of work hours. The predicted network speed is able to be used to identify the end of work hours and update past coverage maps based on the corresponding dates, days of the week, and locations (places).

In order to predict network condition due to such regular fluctuation events, the prediction algorithm 200 is able to predict by utilizing past data (i.e., network speed) collected by time zone and date for a plurality of base stations.

Additionally, the prediction algorithm 200 is able to significantly change network speed due to irregular fluctuation events such as weather (rain, snow, hail, etc.), base station problems, and concerts. In this case, the prediction algorithm 200 is able to predict (identify) event situations corresponding to expected arrival time zones for each location on the driving routes based on the past coverage maps of the same day and the same time zone generated by the map-mapping unit 100 and current network condition of the current autonomous vehicle. Furthermore, relationships between network speed and quality data of the current autonomous vehicle are compared based on the past network condition shown through the coverage maps generated by the map-mapping unit 100 so as to predict the network condition of target location, which will arrive shortly.

For example, when an expected arrival time for an autonomous vehicle to drive from point A to point B is 6 pm, which is one hour later, and an event situation is identified that a concert will be held at point C, which is midway between point A and point B from 5 pm, the prediction algorithm 200 is able to predict that a current network speed is good, but a network speed at point C, which will arrive shortly, will be unstable due to an expected increase in traffic.

The route search unit 300 receives target information including current location and destination of the autonomous vehicle and searches for driving routes to the target destination in conjunction with the map-mapping unit 100.

The route search unit 300 provides, when providing a final searched driving route, data including a network prediction speed predicted through the prediction algorithm 200.

In addition, the route search unit 300 is able to search or re-search for another driving route when a network prediction speed predicted through the prediction algorithm 200 is lower than a preset reference value and thus the communication environment is predicted to be unstable.

In addition, the route search unit 300 is able to apply, when there are a plurality of driving routes to a target destination, network speed of coverages mapped to the plurality of driving routes to the prediction algorithm 200 so as to preferentially provide a driving route with a higher network speed among the plurality of driving routes.

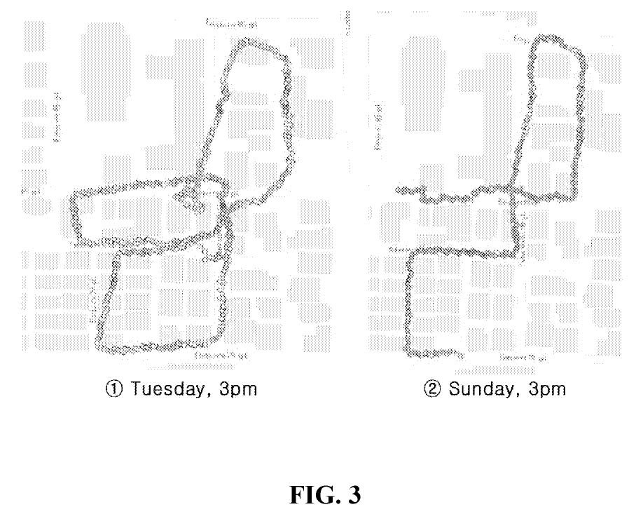

FIG. 3 is a diagram showing a network speed by time and date on a driving route through the system of FIG. 2. A coverage map on the left is a predicted network coverage map at 3 pm on Tuesday, and a coverage map on the right is a predicted network coverage map at 3 pm on Sunday.

In this manner, a system for generating automatically and predicting coverage maps of autonomous vehicle (hereinafter, referred to as a 'system') according to an embodiment of the present disclosure maps network speed by time zone and date in real time on a map in the past, and generates network coverage maps by utilizing location information of the autonomous vehicle and network speed ranges as input data. The generated coverage maps are used to determine irregular network events, and predict future network speed based on based on the input future location information and date-specific data of the autonomous vehicle.

The coverage maps are able to not only provide information on past network condition at current location of the autonomous vehicle, but also predict network speed at future target location based on current data so as to recognize and prepare for communication instability problems in advance.

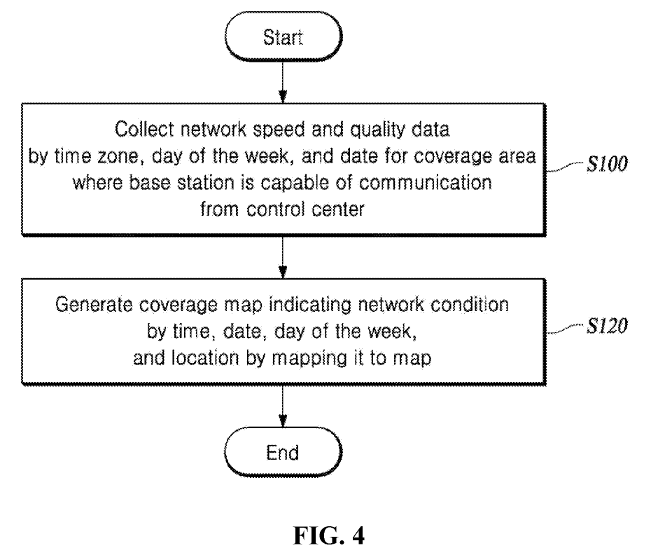

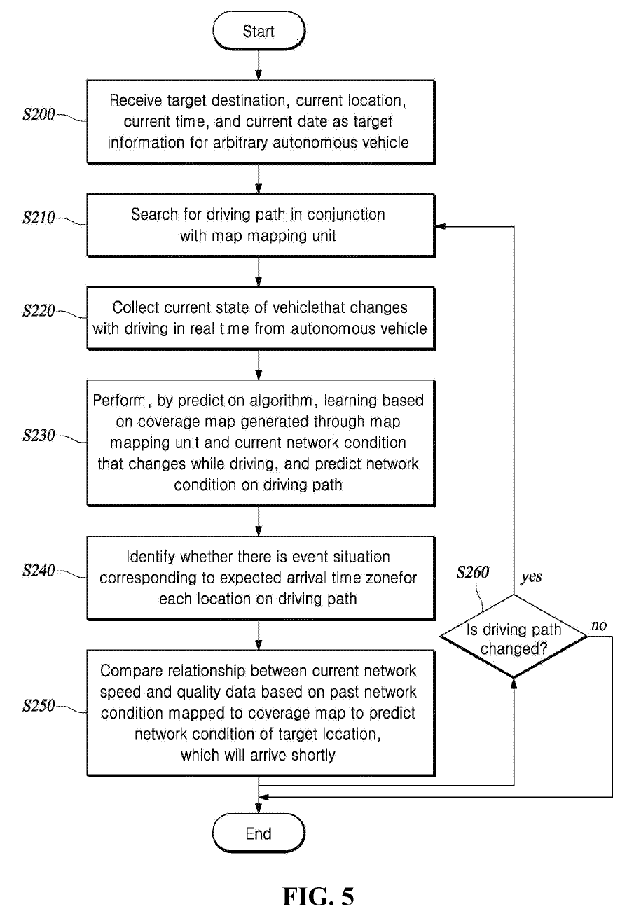

FIG. 4 is an operational flowchart showing a method for automatically generating coverage maps of autonomous vehicle according to an embodiment of the present disclosure, and FIG. 5 is an operational flowchart showing a method for predicting network condition along driving routes of autonomous vehicle based on the coverage maps generated by the method of FIG. 4.

First, referring to FIG. 4, a method for automatically generating coverage maps of autonomous vehicle according to an embodiment of the present disclosure is able to be implemented by basically including the following steps.

In a first step S100, the system according to an embodiment of the present disclosure collects network speed and quality data for a plurality of base stations from a control center by time zone, day of the week, and date.

In a next step S120, a map-mapping unit of the system maps the collected network speed and quality data onto a geographic map to generate coverage maps representing network condition by location, time zone, day of the week, and date.

The coverage maps generated in this manner are able to check network condition according to an area of location-based coverage, and are able to be utilized to predict network condition at least in regular events (e.g., repetitive situations such as commuting hours) through the accumulated past coverage maps by time zone/day of the week/date.

Next, a prediction method according to an embodiment of the present disclosure will be described with reference to FIG. 5.

First, a route search unit of the system receives target information including current location and destination of autonomous vehicle as target information for arbitrary autonomous vehicle (S200).

Then, the route search unit of the system searches for a driving route to the received target destination by linking with the map-mapping unit (S210).

At the same time, a data collection unit of the system collects data on current state of vehicles, including the location, date, day of the week, time, network speed, and quality data of the vehicles, in real time from the autonomous vehicle (S220).

Then, a prediction algorithm of the system performs learning based on coverage maps generated through the process described above in FIG. 4 and current state that changes according to the driving of the autonomous vehicle collected through the data collection unit, and predicts network condition of the corresponding coverages along driving routes, but predicts network condition according to expected arrival time and location of the autonomous vehicle.

In this case, the prediction algorithm is able to identify or predict event situations corresponding to (or occurring in) expected arrival time zones for each location on driving routes of the corresponding vehicles based on current network condition that are able to be checked along the driving routes (S240).

This is able to be utilized later to support the selection of an optimal route based on an event type. For example, when the event is of a type that will be resolved soon or is a regular event type (e.g., during commuting hours), a current searched driving route is able to be maintained as it is, and when the event is of a type that will last a long time or at least last while the vehicle goes to a target location, a detour route is able to be searched to avoid crowded situations, or another optimal route is able to be selected from the current searched driving route.

Then, the prediction algorithm of the system is able to compare relationships between current network speed and quality data (traffic) based on the past network condition included in the coverage maps to predict the network condition of target location, which will arrive shortly (S250).

Then, the route search unit of the system outputs data including a network prediction speed predicted for a future target location that will soon pass on a driving route along with a final searched driving route.

Then, when the network prediction speed is lower than a preset reference value and thus not sufficient for the autonomous vehicle to perform a smooth communication environment, it is possible to check whether to change the driving route (S260).

Accordingly, a change request is able to be received depending on a driving scenario of the autonomous vehicle or by a command from the server.

When the change request is received, the system according to the embodiment of the present disclosure returns to step S210 to perform the process again from the searching for a driving route through the route search unit.

Through this iterative regression process, the method for generating automatically and predicting coverage maps of autonomous vehicle in the present disclosure is able to predict network speeds at future target locations based on current data so as to recognize and prepare for communication instability in advance.

In the above, although the present disclosure has been described in detail through preferred embodiments thereof, it is obvious to those skilled in the art that the present disclosure is not limited to the above-described preferred embodiments, and that various modifications and variations is able to be made without departing from the concept and scope of the present disclosure. Therefore, such modifications and variations should fall within the scope of the claims of the present disclosure.

### DESCRIPTION OF SYMBOLS

100: Map-mapping unit

200: Prediction algorithm

300: Route search unit

400: Data collection unit

What is claimed is:

1. A system for generating automatically and predicting network coverage maps of autonomous vehicle, the system comprising:
a map-mapping unit that collects network speed and quality data for a plurality of base stations from a control center by time of day, day of the week, and date, and maps them onto a geographic map to generate coverage maps representing network condition;
a route search unit that searches for a driving route to the destination by linking with the map-mapping unit, when target information including current location and destination of the autonomous vehicle is input;
a data collection unit that collects data on current states of the autonomous vehicle including at least location, date, day of the week, time, network speed, and quality data of the autonomous vehicle; and
a prediction algorithm that performs learning based on the coverage maps generated by the map-mapping unit and the current state that changes according to the driving of the autonomous vehicle, which is collected by the data collection unit, to predict network condition of coverages mapped on the driving route, but predicts the network condition according to expected arrival time and date of the autonomous vehicle.

2. The system of claim 1, wherein the prediction algorithm identifies event situation corresponding to expected arrival time zone for each location on the driving routes based on the past coverage maps of the same day and the same time zone generated by the map-mapping unit and current network condition of the autonomous vehicle, and compares relationships between current network speed and quality data of the current autonomous vehicle based on the past network condition mapped to the coverage maps generated by the map-mapping unit, so as to predict the network condition of target location, which will arrive shortly.

3. The system of claim 1, wherein the route search unit provides, when providing a final searched driving route, data including a network prediction speed predicted through the prediction algorithm.

4. The system of claim 1, wherein the route search unit searches for, when a network prediction speed predicted through the prediction algorithm is lower than a preset reference value, another driving route.

5. The system of claim 1, wherein the route search unit applies, when there are a plurality of driving routes to the destination, network speed of coverages mapped to the plurality of driving routes to a prediction algorithm so as to prefer entially provide a driving route with a high network speed among the plurality of driving routes.

6. A method for generating automatically and predicting network coverage maps of autonomous vehicle, the method comprising:
collecting, by a map-mapping unit of a system, network speed and quality data for a plurality of base stations from a control center by time of day, day of the week, and date;
mapping, by the map-mapping unit, the collected network speed and quality data onto a geographic map to generate coverage maps representing network condition by location, time zone, day of the week, and date;
collecting, by a data collection unit of the system, data on current state of the autonomous vehicle including at least location, date, day of the week, time, network speed, and quality data of the autonomous vehicle; and
performing, by a prediction algorithm of the system, learning based on the coverage maps generated by the map-mapping unit and the current state that changes according to the driving of the autonomous vehicle collected by the data collection unit to predict network speed for specific time, location, and date.

7. The method of claim 6, further comprising:
receiving, by a route search unit of the system, target information including current location and destination of the autonomous vehicle;
searching for, by the route search unit, driving route to the destination by linking with the map-mapping unit; and
performing, by the prediction algorithm, learning based on the coverage maps generated by the map-mapping unit and the current state that changes according to the driving of the autonomous vehicle to predict network condition of coverages mapped on the driving routes, but predict the network condition according to expected arrival time of the autonomous vehicle and dates.

8. The method of claim 7, wherein the predicting of the network condition comprises:
identifying event situation corresponding to expected arrival time zone for each location on the driving routes based on the past coverage maps of the same day and the same time zone generated by the map-mapping unit and current network condition of the autonomous vehicle; and
comparing relationships between network speed and quality data of the current autonomous vehicle based on the past network condition mapped to the coverage maps generated by the map-mapping unit, so as to predict and provide the network condition of target location, which will arrive shortly.
